(19) United States
(12) Patent Application Publication
(10) Pub. No.: US 2009/0314605 A1
(43) Pub. Date: Dec. 24, 2009

(54) Motorcycle racing clutch lever release mechanism

(76) Inventor: Randy Haguen, Lakewood, CO (US)

Correspondence Address: Randy Haugen, 1971 S. Estes St., Lakewood, CO, 80227, US

(21) Appl. No.: 12/386,680

(22) Filed: Apr. 22, 2009

Related U.S. Application Data
(60) Provisional application No. 61/124,952, filed on Apr. 22, 2008.

(51) Int. Cl. F16D 19/00

(52) U.S. Cl. 192/99 R

(57) ABSTRACT

A motorcycle racing clutch mechanism that provides the automatic release of the clutch lever and adjustability of the speed at which the clutch lever is automatically released using a hydraulic fluid flow.

### This application claims the benefit of my provisional patent application titled “MOTORCYCLE RACING CLUTCH LEVER RELEASE MECHANISM” having Ser. No. 61,124,952 filed on Apr. 22, 2008, incorporated herein in it's entirety by reference.

### SPECIFICATION

In the sport of off road racing, whether motorcycles or ATV's, competitive events are usually started from a stopped position, behind a backward falling gate. Competitors are lined up beside one another behind this gate, waiting for the previous race to finish. During this time an indication is given that the race will start in 2 minutes. This is followed by yet another indication that there is now only 1 minute left until the start of the event.

Once the 1-minute indication has been given, riders will make final preparations for the race such as putting on their goggles, pulling tear offs, checking the bike, etc. Immediately prior to the gate being dropped the starter will turn the 1-minute indicator sideways, letting the riders know the gate is about to drop, signaling the beginning of the race.

At this time the rider will focus his attention on the gate in front of him pulling his clutch lever in with his left hand, so that he may put his machine in gear for the race with his left foot, and hold his throttle at about ¾ open, with his right hand. At the first sign of movement of the gate, the rider will twist the throttle to full, while releasing the clutch lever in such a was as to minimize wheel spin while attempting to beat all the other riders to the first obstacle. Doing so successfully is known as the holeshot.

The holeshot enables a rider to see the track clearly, and he is unimpeded by slower riders, which allows him to choose the specific line, or fastest route to be taken on the track. This is also the only time in the race that a rider can pass all the other riders at once.

Just as in drag racing, motocross vehicles are capable of spinning the rear wheel excessively during the application of the vehicle's power to the ground. That the bike can spin the rear wheel, while the clutch is being released, regardless of the start surface, is a given. This is why riders spend hours and hours trying to master the release of the clutch at full throttle, in an effort to eliminate excessive wheel spin, or front wheel elevation, both of which are “loss of control states”. On surfaces with lots of traction, such as concrete, a rider will try to release the clutch lever at a certain speed, so that no wheel spin occurs, conversely, on a surface that offers little traction the rider will release the clutch lever at a different speed, again in an effort to maintain maximum traction.

When, the rider experiences a “loss of control” he becomes vulnerable to crashing into another rider, or being crashed into by another rider. During a loss of control a rider must reduce throttle immediately, and this almost always results in a poor start.

To master this skill, in a relaxed environment, requires extensive practice, and yet is still elusive even at the professional level. Mastering this skill in racing conditions, where the rider cannot even hear his own machine, and is attempting to beat the other riders to the first obstacle, is fraught with potential for failure due to the human element involved in the release of the clutch lever at the handlebar. This skill becomes even more difficult to master when the start surface changes constantly during the course of the day, or from inclement weather. When encountering different start surfaces each and every weekend, mastery of this skill is extremely difficult.

Therefore, in racing conditions, it would be advantageous for a rider to have the ability to remove the human element from this start process, and utilize a mechanical device to automatically release the clutch lever, which is critical to successful starts in motocross racing.

This invention provides the rider with an automatic release of the clutch lever, the speed of which, or the duration of time that the release of the clutch lever may consume, may be adjusted, for the available traction on a given start surface, which occurs without human assistance.

The current invention comprises generally, of a CNC machined to specification, T7075 billet aluminum clamp block as shown in Figure A, designed to be clamped to a motorcycle handlebar by means of a single bolt as shown in Figure B. A known clutch lever is attached to the clamp block for the purpose of engaging and disengaging the clutch of the motorcycle as seen in Figure C.

Within the clamp block various channels and orifices are machined, as shown in Figure D, and filled with grease during assembly. This creates a hydraulic flow for the purpose of controlling the speed at which the clutch lever is released, automatically, without human interaction, to re-engage the clutch, moving the vehicle forward. A plunger, resting against the clutch lever, where the lever meets the clamp block, controls the speed of re-engagement of the clutch lever, as shown in Figure E.

Immediately prior to the gate being dropped in a race a rider will pull the clutch lever in to put the motorcycle in gear, preparing for the start of the race. The rider will then push the start button on the front of the clamp block; creating a hydraulic flow behind the plunger, moving it out, until it rests against the lever, as shown in Figure F. The rider then “dumps” the clutch, or lets go of the lever quickly, this activates the plunger to release the clutch lever at the adjusted rate of speed, and the hydraulic flow behind the plunger is forced back, by the spring loaded clutch within the engine, releasing the clutch lever at a precise rate of speed.

The speed of clutch lever release mechanism is controlled by a control valve that provides for a vast amount of adjustment, incrementally available on the valve control knob on the top of the invention.

### BACKGROUND OF THE INVENTION

(a) Field of the Invention

This invention relates generally to motorcycles, and more particularly motorcycle clutch systems.

(b) Description of Related Art

Today's motorcycle clutch system consists of a hand actuated clutch lever that is used to engage and disengage the clutch mechanism and assembly located at the engine, as taught by one or more of the following patent numbers, U.S. Pat. Nos. 6,533,056, 6,250,447, 6,786,312, 3,990,553, 2005/0029073, 6,227,342, 5,636,518.

It accomplishes this by means of a clutch cable spanning the distance between the clutch lever and the clutch assembly. The clutch cable is of a known design having an inner wire disposed coaxially within a tubular flexible outer casing so that the inner wire can move axially within the outer casing to mechanically couple movement of the clutch lever assembly.

Pulling the clutch lever, at the handlebar, toward the handlebar, pulls the inner wire of the clutch cable away from the spring-loaded clutch assembly to disengage the clutch, as the clutch lever is pulled. Releasing the clutch lever, or allowing it to move away from the handlebar, allows the inner wire of the clutch cable to move back towards the clutch assembly, allowing the spring-based clutch to re-engage.

Although, the prior art teaches that the modem motorcycle clutch systems integrate new technology for the adjustment of the clutch cable, and utilize hydraulic actuated systems to create consistent feel and modulation of the clutch lever, there is no prior art that discusses or teaches, an ability to provide the automatic release of the clutch lever by any mechanism.

### SUMMARY OF THE INVENTION

This invention addresses this issue by providing an automatic clutch lever release system, that can be retrofitted to an existing motorcycle, originally manufactured with a clutch cable, and a hand actuated clutch lever. The retrofit clutch lever release system includes (i) a handlebar mountable, automatic clutch release lever system which may or may not have a master hydraulic cylinder for use with a known motorcycle hydraulic clutch system (ii) a clutch lever plunger, which automatically, incrementally, and consistently releases the clutch lever for the purpose of automatically, re-engaging the clutch in racing conditions, (iii) a dowel pin, known as a start button that initializes the plunger, for the use of the clutch release lever plunger, (iiii) a cable adjustment bolt used to adapt an existing clutch cable into the clutch lever release system, (iiiii) a clamp block which provides various orifices and channels that are utilized to create the hydraulic flow which enables the rider to adjust the speed at which the clutch lever release system, automatically releases the clutch lever, it also provides a means by which the system may be retrofitted onto any motorcycle, or mounted to the handlebar, (iiiiii) a valve adjustment knob, which adjusts the speed at which the plunger automatically releases, the clutch lever release system, to re-engage the clutch without human intervention, (iiiiiii) a clamp block sleeve made of Teflon which enables the entire system to rotate on the handlebar in the event of a crash, (iiiiiii) a clutch lever adapted for use with the clamp block.

Thus the invention alleviates many concerns associated with the release of the clutch lever during the start of motorcycle racing events where the competition is started from a stopped position.

The invention enables racing enthusiasts to eliminate the human element involved in the release of the clutch release lever, and allow the invention to automatically release the clutch lever, to re-engage the clutch. This mechanical release of the clutch lever, affords a more consistent re-engagement of the clutch, which eliminates back wheel spin and front wheel elevation.

Further this invention, due to it's elimination of rear wheel spin enables the competitor to maneuver or control the motorcycle much earlier during the start of races, enabling greater rider control, which increases safety.

The invention enables a competitor to adjust the speed at which clutch lever moves to re-engage the clutch, dependent upon the available traction on the start surface or lack thereof. Once activated, the invention mechanically, and automatically engages the clutch on the motorcycle under racing conditions, at a preset, and adjustable speed, without human interaction.

This invention also provides normal clutch usage and only provides the racing clutch release mechanism, when armed by the competitor or rider, by the use of a dowel or start button.

To paraphrase some of the more precise language subsequently presented in the claims, a motorcycle clutch assembly according to the invention for a motorcycle having a handlebar, a clutch lever, a clutch cable, an engine and a clutch, includes (i) a handlebar mountable, automatic clutch release lever system which may or may not have a master hydraulic master cylinder for use with a known motorcycle hydraulic clutch system, (ii) a clamp block used to mount the system to the handlebar, (iiii) a cable adjustment bolt used to adapt an existing clutch cable into the clutch lever release system.

One embodiment may include a master hydraulic cylinder used in known hydraulic motorcycle clutch systems. Yet another embodiment may include the use of a bolt to adjust the proximity of the lever to the handlebar for use by competitor with small hands.

### BRIEF DESCRIPTION OF THE SEVERAL VIEWS OF THE DRAWING

FIG. 1 of the drawings is a top view of the current invention, with a known clutch lever, mounted onto the handlebar.

FIG. 2 of the drawings is a view from the top right of the current invention showing the single bolt clamp to mount the invention to the handlebar, the cable bolt with which any common motorcycle cable may be attached for use with any known lever. The speed control valve knob can also be seen, as well as the start button, which activates the invention.

FIG. 3 of the drawings is a view from the left side of the current invention where any known lever may be attached. The cable bolt to attach any known cable from the motorcycle can also be seen, along with speed control valve knob and start button. The Teflon ring to which the handlebar is mounted can also be seen.

FIG. 4 is a front view of the current invention.

FIG. 5 is transparent top view of the current invention whereby the internals can be seen.

FIG. 6 is left have view of the clamp block, unassembled with no clutch lever attached.

### DETAILED DESCRIPTION OF THE INVENTION

This invention relates to the operating mechanisms in use during racing conditions or during conventional use, of a motorcycle clutch lever, whether the clutch is hydraulic or mechanical, particularly to mechanisms fitted to the handlebars of a motorcycle that are used to control a hand actuated clutch lever.

Various motorcycle clutch levers are well known and include a hydraulic clutch lever mechanism as taught in U.S. Pat. No. 6,227,342, and U.S. Pat. No. 5,636,518. Adjustability of these mechanisms is taught by U.S. Patent number 2005/0029073.

Although these patents teach that a hydraulic clutch provides less drag, is easier and more sensitive to operate, the prior art does not provide a means by which, the speed at which the clutch release lever, is released, may be increased or decreased, under racing conditions, nor does the prior art provide a means by which, the release of the clutch lever, can be performed automatically without human assistance.

The present invention provides a means of altering, or adjusting the speed at which the clutch lever may be released for the purpose of engaging the clutch to move the motorcycle forward, under racing conditions. It further accomplishes this automatically, and eliminates the problems so commonly associated with the human execution of this process.

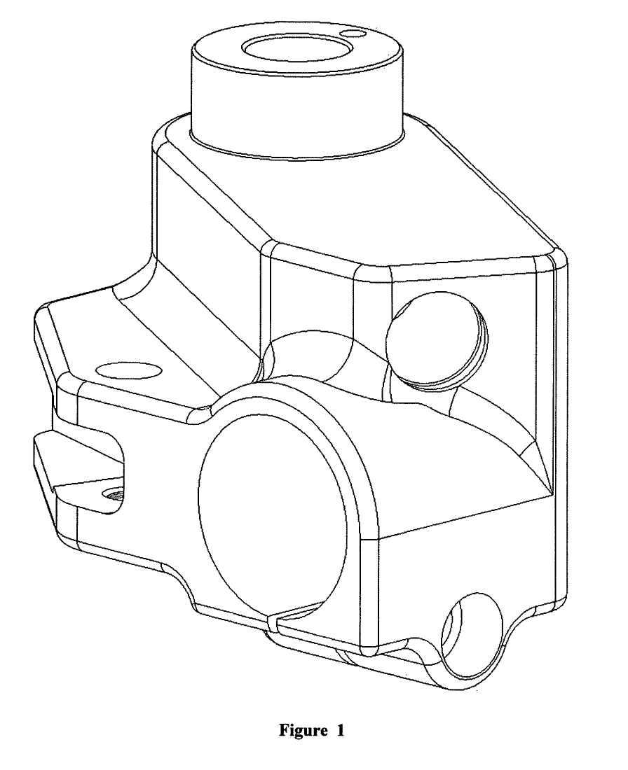

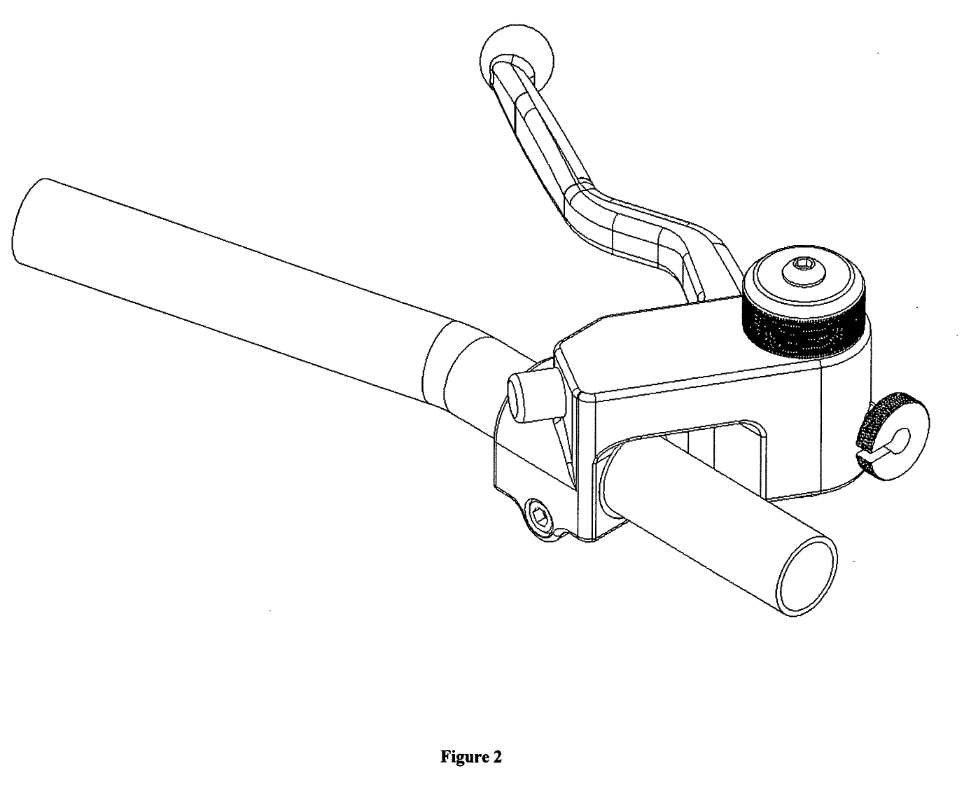

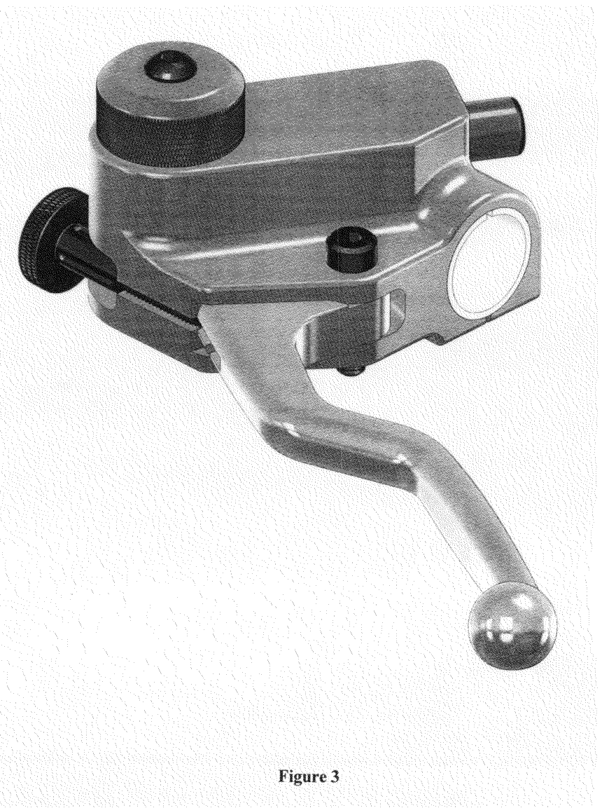

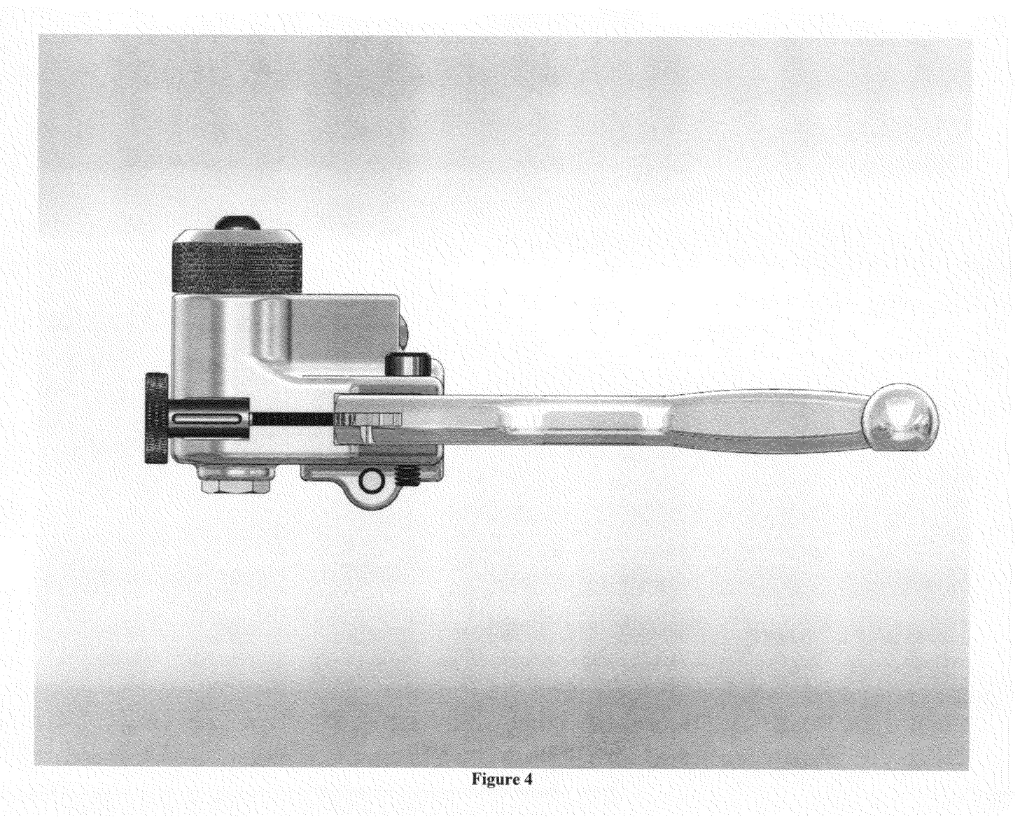

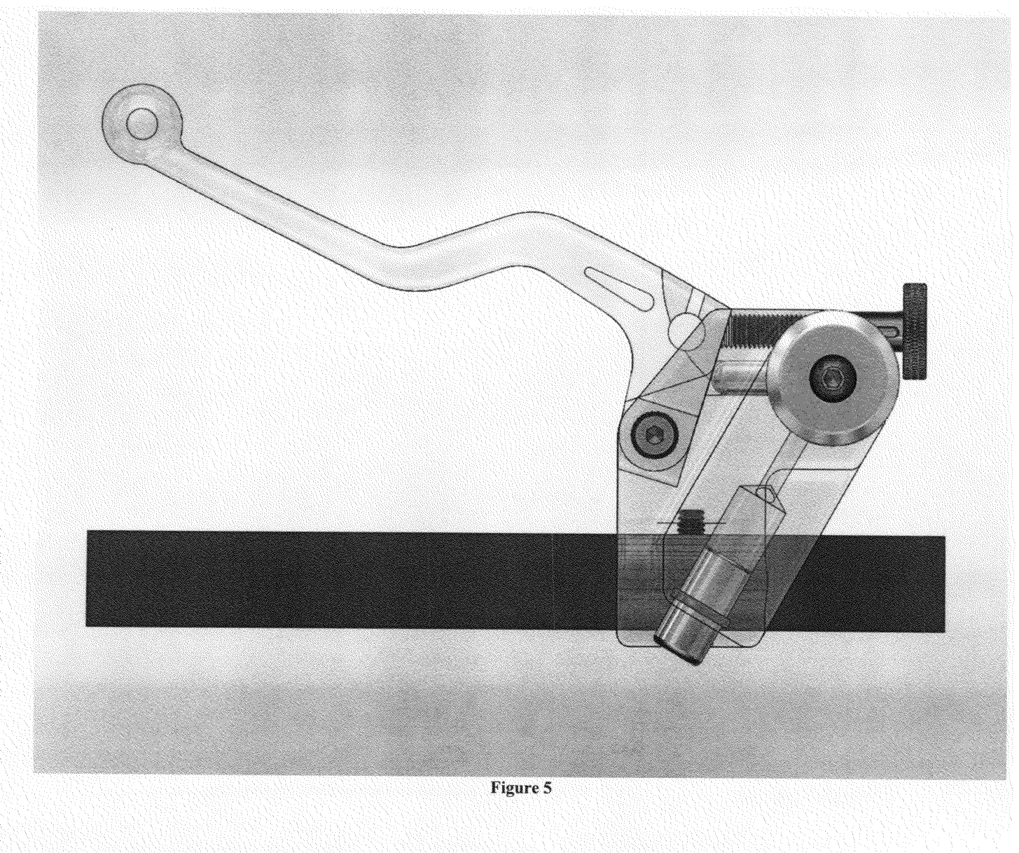

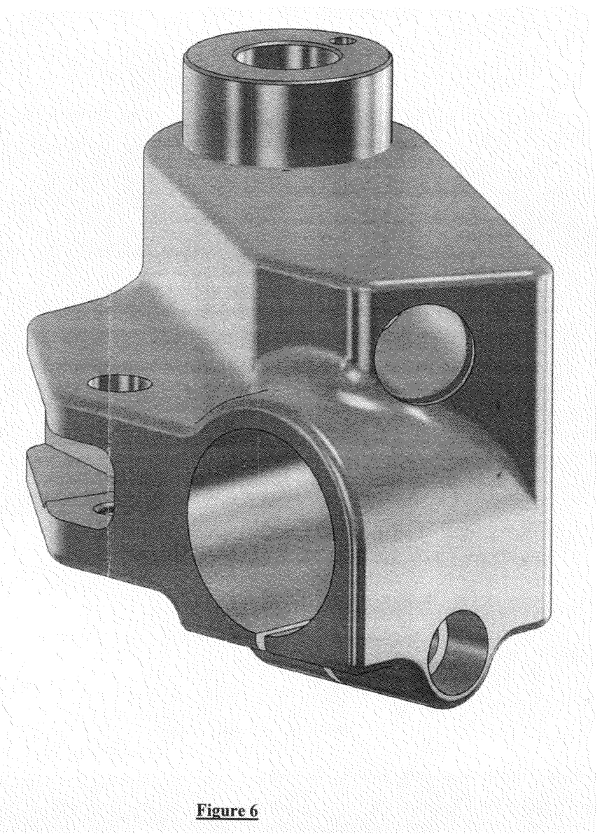

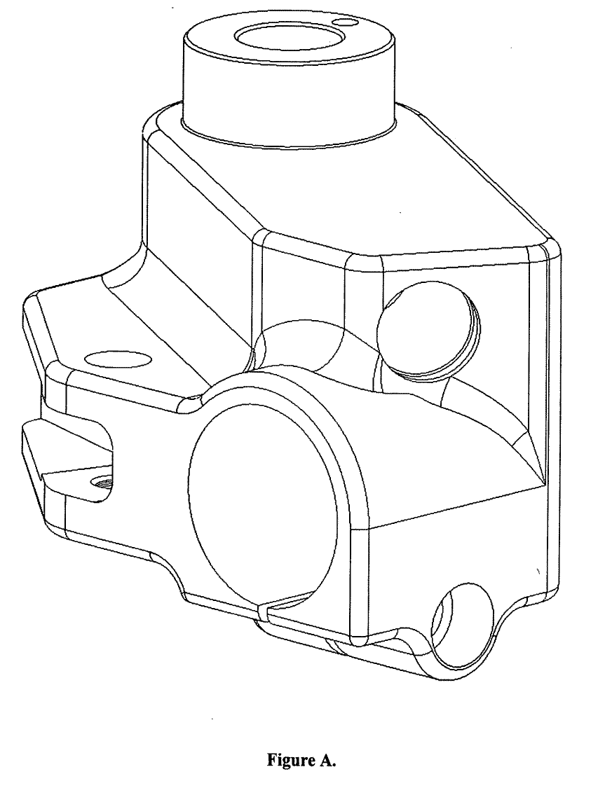

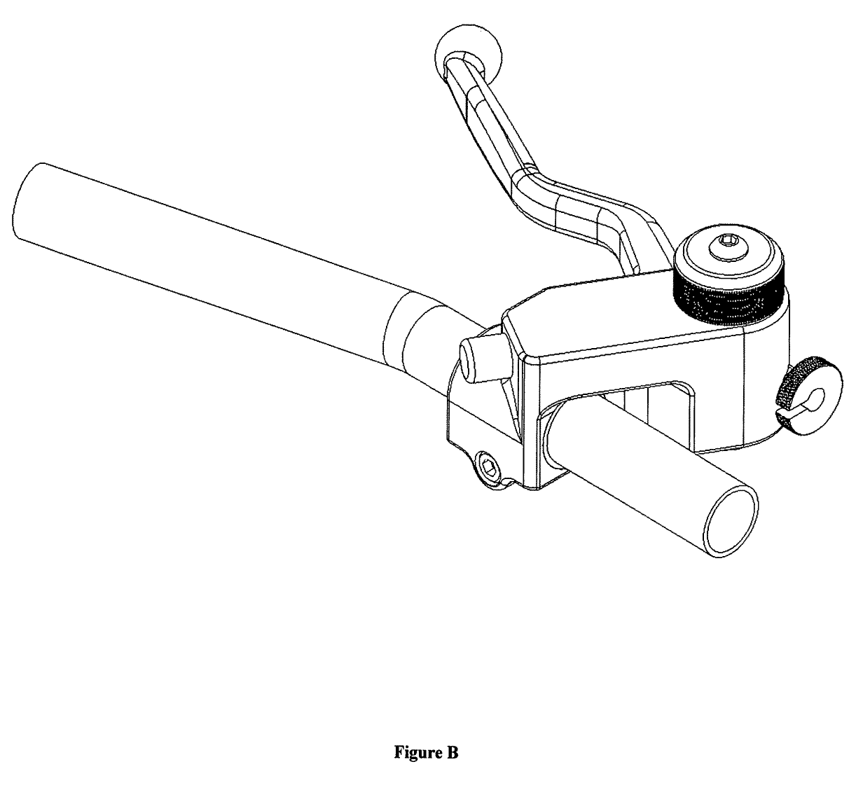

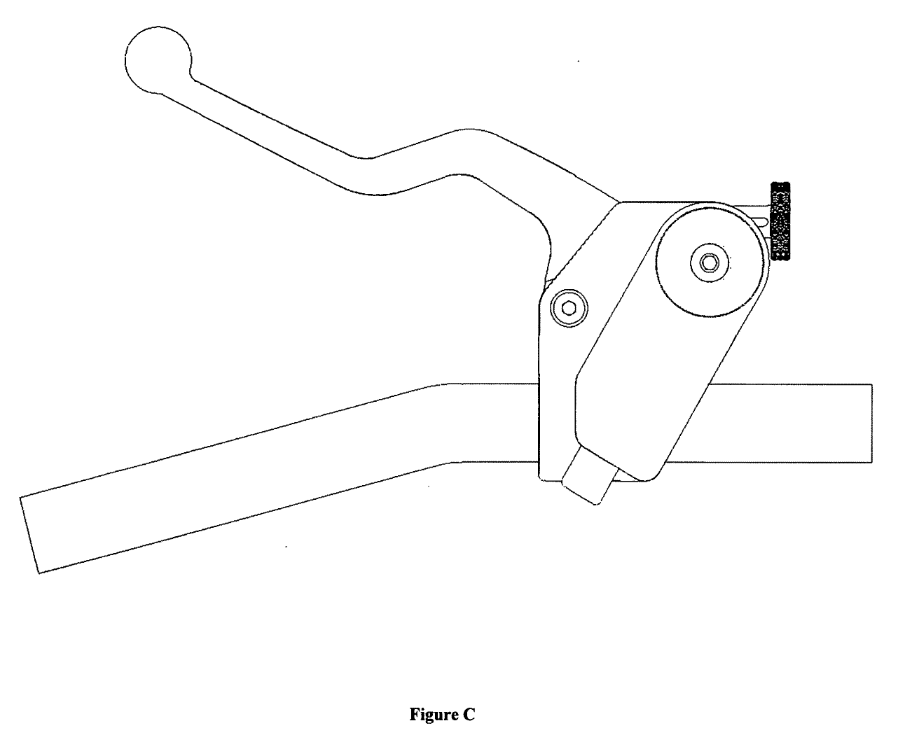

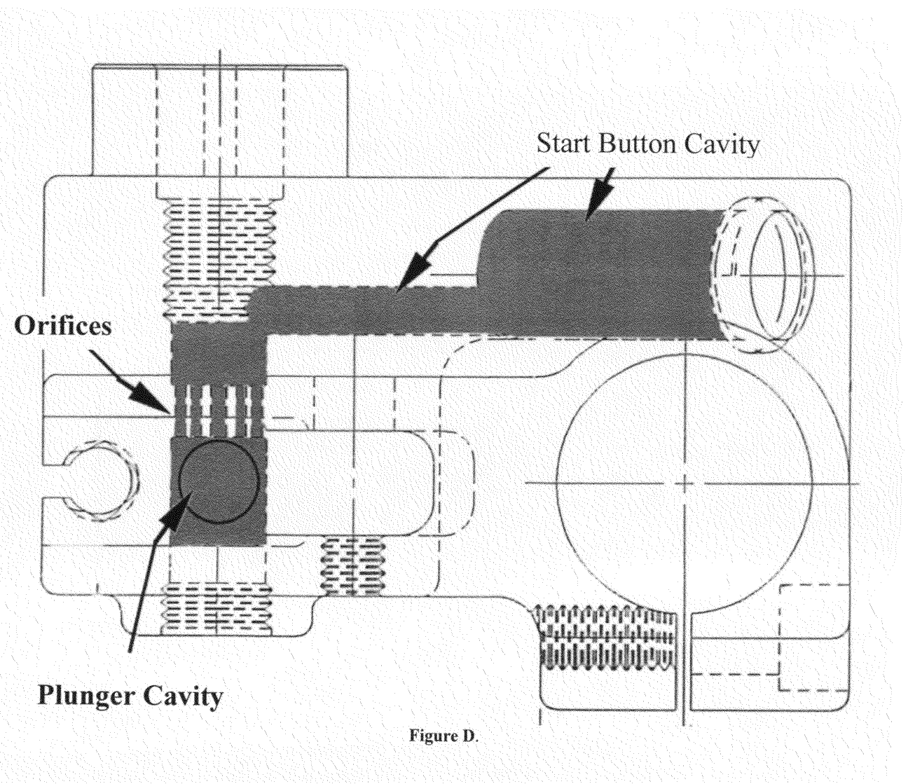

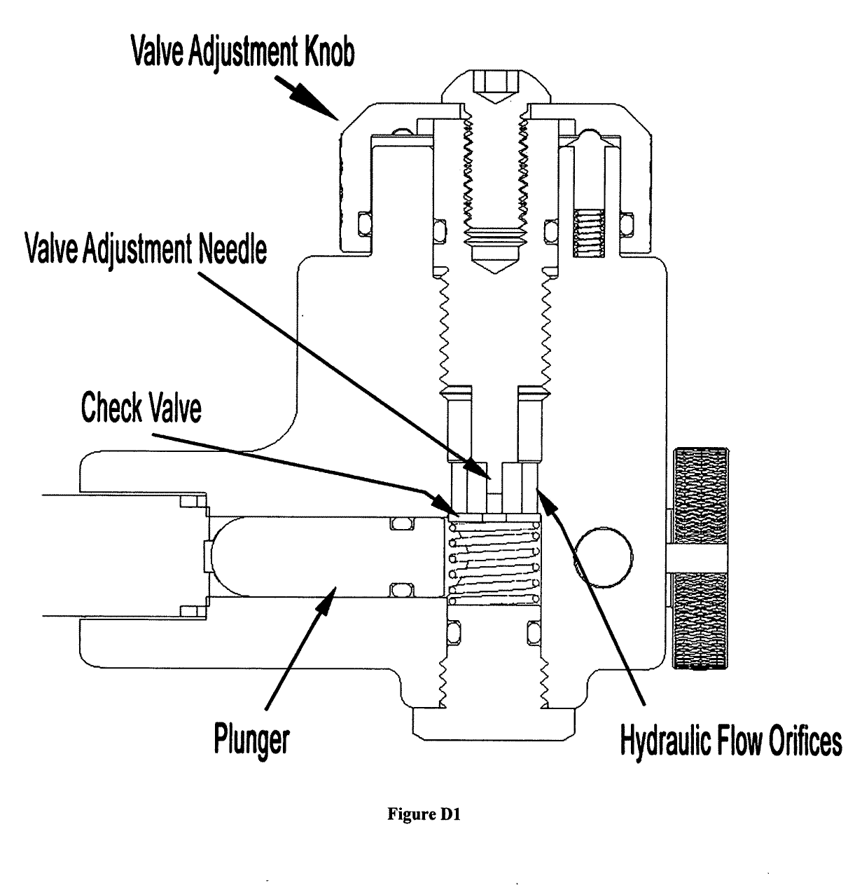

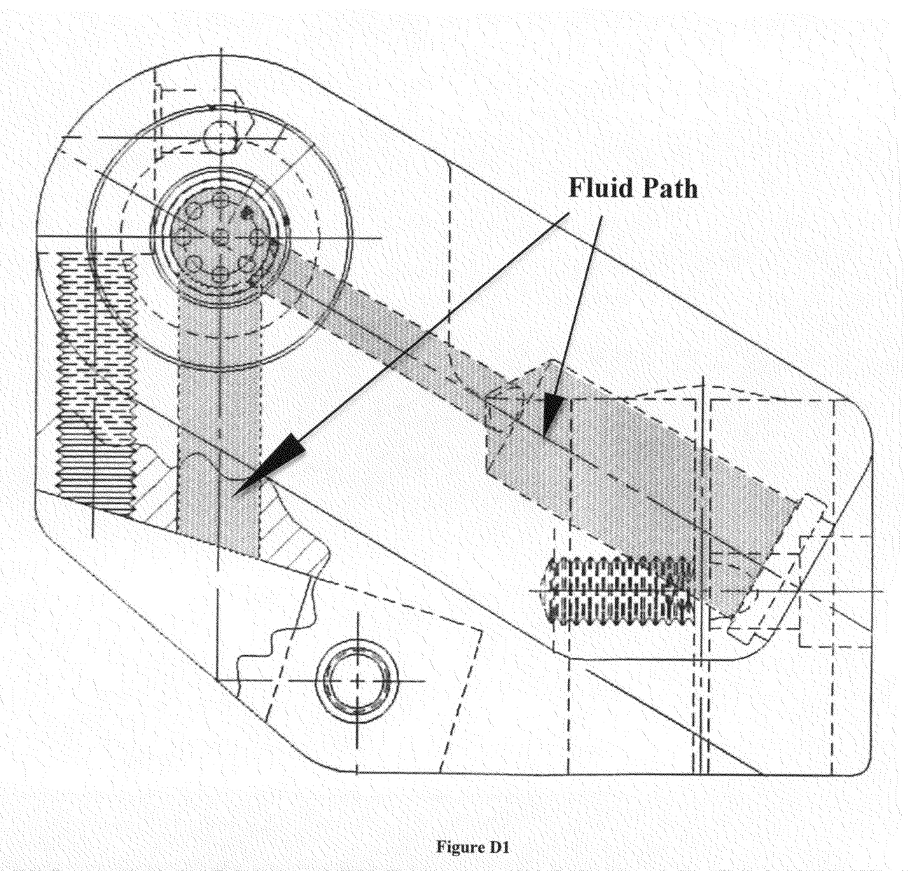

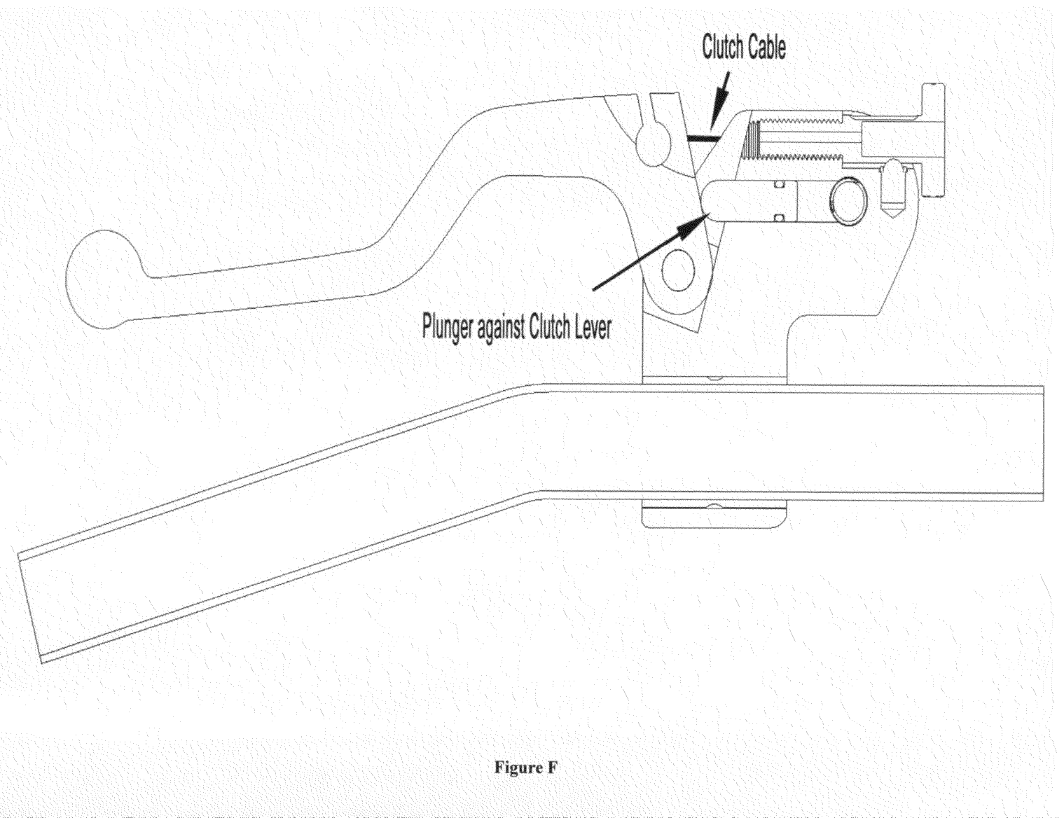

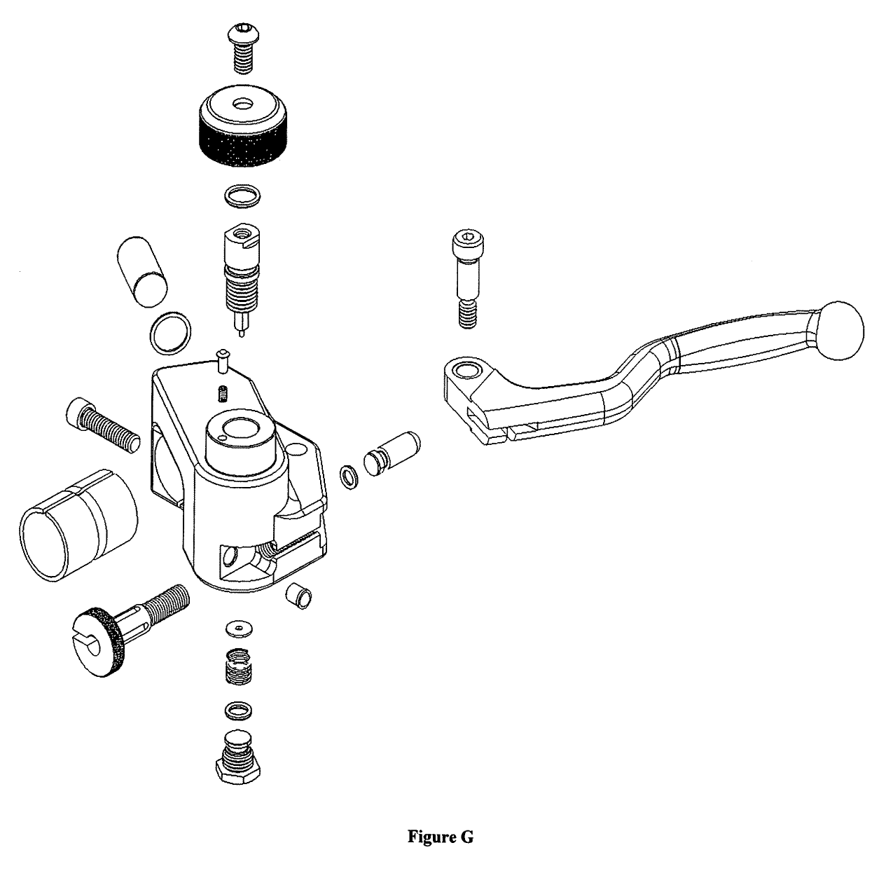

The present invention is manufactured from T-7075 aircraft aluminum and is known as a clamp block, as shown in FIG. 1, which is mounted to the handlebars of any motorcycle. A clutch lever is included and adapted for use with the clamp block as shown in FIG. 2. The clamp block is manufactured to dimensions as specified and provides a pivot mounting area for the included clutch lever. The clamp block contains a horizontal, machined cavity directly behind the start button, as shown in Figure D, that continues to the Valve adjustment needle as shown in Figure D1, vertically downward and through, to the plunger, as shown in figure D, and Figure D1. This cavity is filled with oil that creating a hydraulic flow, the hydraulic fluid flow is used to move the plunger against the clutch lever in the disengaged position as shown in Figure F, it also controls the speed at which the clutch lever is automatically released, by the use of the invention.

The current invention is utilized by the rider of the motorcycle when preparing for the start of a competitive event. The rider will pull in the clutch to shift the bike in gear preparing for the start of the race, as shown in Figure F. When the rider shifts the motorcycle into gear, having the clutch pulled in, or engaged, he will arm the invention by pushing a button (#19) on the back, upper portion of the clamp block, as shown in Figure F, which falls directly under his left thumb, and is easily reached while pulling in the clutch lever.

Once activated the rider will then release or “dump” the clutch lever when the gate is dropped. This triggers the invention to automatically release the clutch lever at the pre-adjusted speed, for the purpose of obtaining a consistent, incremental and timely release of the clutch to maximize traction on the given surface, dirt, concrete, or mud, without human assistance.

After the clutch lever is released during the start of the race, the spring-loaded clutch within the engine, returns the clutch lever to it's disengaged position also moving the plunger to it's original position, which returns normal clutch functionality, as shown in Figure C, and the invention is ready to be used again when armed by the rider at the start of the next race.

The assembly and function of the current invention can be seen in Figure G and begins with the clamp block, (#01), into which the dowel pin (start button) (#19) is inserted, and sealed by an O-ring (#14). This is followed by (#06), the adjustment needle that is screwed into the top of the clamp block, (#01), which sealed by an O-ring (#13). The adjustment knob (#07) is screwed into the top of the adjustment needle using a button head cap screw (#18), as shown in Figure G. The adjustment knob (#07), on its inner face has machined detents, that contact a spring (#09) activated ball plunger (#16) for purposes of fine adjustment.

Directly below that is a check valve (#04), followed by the check valve spring (compression spring) (#10). This is sealed by a single plug (#03), using an O-ring (#12), which is screwed into the bottom of the clamp block (#01).

The clamp block (#01) is filled with hydraulic fluid, and The plunger (#02), sealed by an O-ring (#11), is inserted into the plunger cavity as shown in Figure D1. This completely seals the hydraulic fluid within the clamp block (#01). The clutch lever is held in place by a socket head shoulder screw (#21) as seen in Figure G. The cable adjustment bolt (#05), is inserted into the clamp block (#01) and contacts a ball plunger (#17) for the purposes of fine adjustment.

A Teflon sleeve (#08) slides into the clamp block (#01) as shown in Figure G, for the purpose of allowing rotational movement on the handlebar in the event of a crash. The sleeve (#08), and the entire clamp block (#01) are held in place, or mounted by a single socket head cap screw (#20) as shown in Figure G.

I. A motorcycle clutch lever mechanism that provides and controls the automatic release of the clutch lever.

II. A motorcycle clutch lever mechanism that provides and controls adjustability of the speed at which the automatic release of the clutch lever is performed.

III. A motorcycle clutch lever mechanism that utilizes hydraulic fluid flow as a means to control the automatic release of the clutch lever.

IV. A motorcycle clutch lever mechanism that utilizes hydraulic fluid flow, as a means to adjust the speed at which automatic clutch release is performed.

V. A motorcycle clutch lever mechanism that utilizes the stored energy of the spring-loaded clutch within the engine of the motorcycle, to enable the automatic clutch release functionality.

VI. A motorcycle clutch lever mechanism that when used for racing automatically returns normal clutch functionality, immediately after the automatic clutch release mechanism completes its functionality.

VII. A motorcycle clutch lever mechanism that utilizes its start button to create a hydraulic flow enables it's functionality.

VIII. A motorcycle clutch lever mechanism that utilizes specific channels and orifices as set forth in the attached diagrams, to control the automatic clutch release functionality.

IX. A motorcycle clutch lever mechanism that utilizes specific channels and orifices as set forth in the attached diagrams, to control the speed at which the automatic clutch release functionality is regulated, via hydraulic fluid flow.

X. A motorcycle clutch lever mechanism that utilizes a tapered needle valve as set forth in the attached diagrams, to control the automatic clutch release functionality, via hydraulic fluid flow.

XI. A motorcycle clutch lever mechanism that utilizes a check valve as specified in the attached drawings, to ease the arming function of the invention via the start button.

XII. A motorcycle clutch lever mechanism that utilizes a plunger as set forth in the attached drawings, to accomplish the automatic release of the clutch lever.

XIII. A motorcycle clutch lever mechanism that is mounted to the handlebars and provides automatic clutch release functionality as well as the adjustment of the speed at which the automatic clutch release function is performed.

XIV. A motorcycle clutch lever mechanism that provides the automatic release of the clutch lever, and the ability to adjust the speed at which the clutch lever is released for the purpose of minimizing rear wheel spin, or front wheel elevation.
